(19) United States
(12) Patent Application Publication
(10) Pub. No.: US 2025/0231085 A1
(43) Pub. Date: Jul. 17, 2025

(54) WAVEGUIDE MEASUREMENT DEVICE

(71) Applicant: Goertek Optical Technology Co., Ltd., Weifang, Shandong (CN)

(72) Inventors: VEYSI DEMIR, Shangdong (CN); Angus Wu, Shangdong (CN)

(73) Assignee: Goertek Optical Technology Co., Ltd., Weifang, Shandong (CN)

(21) Appl. No.: 18/853,233

(22) PCT Filed: Apr. 11, 2022
(86) PCT No.: PCT/CN2022/086110

§ 371 Date: Oct. 1, 2024

(51) Int. Cl. G01M 11/00

(52) U.S. Cl. CPC G01M 11/35; G01M 11/33

(57) ABSTRACT

Embodiments of the present disclosure disclose a waveguide measurement device. The waveguide measurement device comprises: a receiver device comprising a lens, the lens being configured to receive light coupled out of a predetermined region of a waveguide; a fiber optic device configured to conduct light received by the lens; and a detection device coupled to the receiver device via the fiber optic device, the detection device being configured to be able to calculate an intensity of light coupled out of the predetermined region of the waveguide.

### CROSS-REFERENCE TO RELATED APPLICATIONS

The present disclosure is a National Stage of International Application No. PCT/CN2022/086110 filed on Apr. 11, 2022, which is hereby incorporated by reference in its entirety.

### TECHNICAL FIELD

The present disclosure relates to the technical field of optics, and more particularly to a waveguide measurement device.

### BACKGROUND

In the field of augmented reality, performance metrics such as optical efficiency and brightness of a measurement waveguide are among the most critical metrics for final performance of a diffractive waveguide. Such measurements may involve collecting and quantifying radiation amount and uniformity of light that may reach the human eye. Nevertheless, inaccurate evaluation on performance of a waveguide occurs because existing apparatuses for waveguide measurement are non-portable and expensive with poor measurement convenience and insufficient measurement precision.

### SUMMARY

An object of the present disclosure is to provide a novel technical solution for a waveguide measurement device.

According to a first aspect of the present disclosure, a waveguide measurement device is provided. The waveguide measurement device includes: a receiver device including a lens, the lens being configured to receive light coupled out of a predetermined region of a waveguide; a fiber optic device configured to conduct light received by the lens; and a detection device coupled to the receiver device via the fiber optic device, the detection device being configured to be able to calculate an intensity of light coupled out of the predetermined region of the waveguide.

Optionally, the waveguide measurement device further includes: a movement device on which the receiver device is provided, the movement device being configured to be able to move the receiver device in a predetermined direction and/or to reorient the lens.

Optionally, the movement device includes a first linear displacement device and a first rotation device, the first rotation device and the first linear displacement device being connected and secured to each other, the receiver device being provided on the first rotation device or the first linear displacement device.

Optionally, the waveguide measurement device further includes an off-axis field generating device configured to be able to assist the waveguide in coupling out an off-axis field.

Optionally, the off-axis field generating device includes a second rotation device configured to be able to rotate the waveguide about a center of an in-coupling grating of the waveguide.

Optionally, the off-axis field generating device includes a reflection device configured to reflect collimated light so that the collimated light is incident obliquely onto an in-coupling grating of the waveguide.

Optionally, the waveguide measurement device further includes a second linear displacement device and a third rotation device, the third rotation device and the second linear displacement device being connected and secured to each other, the reflection device being provided on the third rotation device or the second linear displacement device and being able to be moved parallel to the waveguide and able to be rotated.

Optionally, the waveguide measurement device further includes a third linear displacement device configured to move the waveguide to enable light reflected by the reflection device to be incident obliquely onto the in-coupling grating of the waveguide.

Optionally, the waveguide measurement device further includes a aperture device, the aperture device being located on the light incident side of the lens, and the aperture device being opposite to the lens.

Optionally, the fiber optic device includes a fiber body and a fiber core, the fiber core being connected to one end of the fiber body, and the detection device being coupled to the other end of the fiber body, the fiber core being provided opposite to the lens.

According to an embodiment of the present disclosure, the fiber optic device can be bent at will, and the length thereof can be selected according to actual needs. The detection device and the receiver device are coupled together via the fiber optic device. In this way, the receiver device can be placed anywhere for waveguide measurement. This makes the waveguide measurement device lighter and the waveguide measurement easier.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings, which are incorporated in and constitute a part of this specification, illustrate embodiments of the present disclosure and together with the description serve to explain the principles of the present disclosure.

FIG. 1 is a schematic view of a waveguide measurement device according to an embodiment of the present disclosure.

FIG. 2 is a schematic view of a second waveguide measurement device according to an embodiment of the present disclosure.

FIG. 3 is a schematic view of a third waveguide measurement device according to an embodiment of the present disclosure.

FIG. 4 is a schematic view of a fourth waveguide measurement device according to an embodiment of the present disclosure.

FIG. 5 is a schematic view of a fifth waveguide measurement device according to an embodiment of the present disclosure.

FIG. 6 is a schematic view of determining a measurement spot size of a predetermined color on a waveguide by using a waveguide measurement device according to an embodiment of the present disclosure.

FIG. 7 is a schematic view of determining the loss of light of a predetermined color on a waveguide using a waveguide measurement device according to an embodiment of the present disclosure.

FIG. 8 is a combined graph of radiation, luminous flux, or luminance for optical coupling into and out of a waveguide according to an embodiment of the present disclosure.

FIG. 9 is a combined luminance graph generated by scanning an out-coupling grating at a distance from the waveguide to the pupil of the waveguide measurement device according to an embodiment of the present disclosure.

### LIST OF REFERENCE SIGNS

100, detection device;
200, fiber body;
300, receiver device;
301, lens;
302, fiber core;
303, receiving surface;
400, aperture device;
500, movement device;
501, first linear displacement device;
502, first rotation device;
601, second rotation device;
602, reflection device;
603, second linear displacement device;
604, third rotation device;
605, rotation shaft;
606, third linear displacement device;
700, waveguide;
701, in-coupling grating;
702, out-coupling grating;
703, emitting surface; and
800, light emitting device.

### DETAILED DESCRIPTION

Various exemplary embodiments of the present disclosure will now be described in detail with reference to the drawings. It should be noted that the relative arrangement of the components and steps, the numerical expressions, and numerical values set forth in these embodiments do not limit the scope of the present disclosure unless it is specifically stated otherwise.

The following description of at least one exemplary embodiment is merely illustrative in nature and is in no way intended to limit the present disclosure, its application, or uses.

Techniques, methods and apparatus as known to one of ordinary skill in the relevant art may be discussed in less detail but are intended to be part of the specification where appropriate.

In all of the examples illustrated and discussed herein, any specific value should be interpreted to be illustrative only and non-limiting. Accordingly, other examples of the exemplary embodiments could have different values.

It is to be noted that similar reference numerals and alphabetical letters refer to similar items in the following figures. As such, once an item is defined in one figure, there is no need for further discussion on the item in following figures.

According to one embodiment of the present disclosure, a waveguide measurement device is provided. The waveguide measurement device includes a receiver device 300, a fiber optic device and a detection device 100.

The receiver device 300 includes a lens 301. The lens 301 is configured to receive light coupled out of a predetermined region of a waveguide 700.

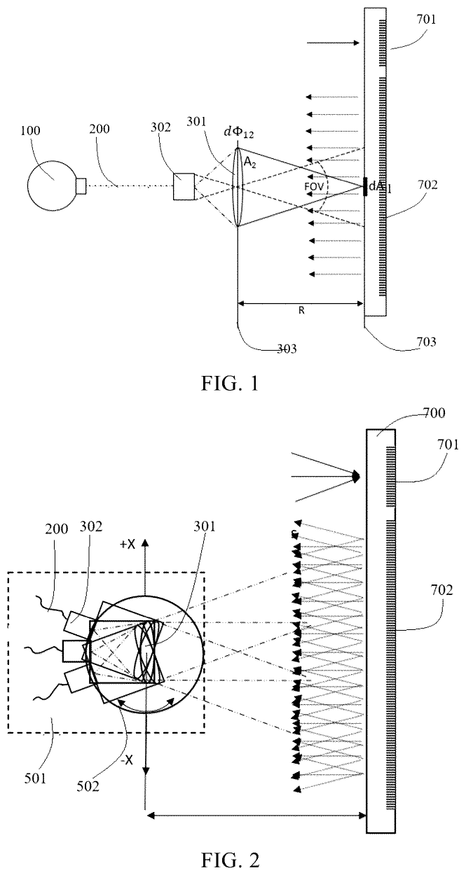

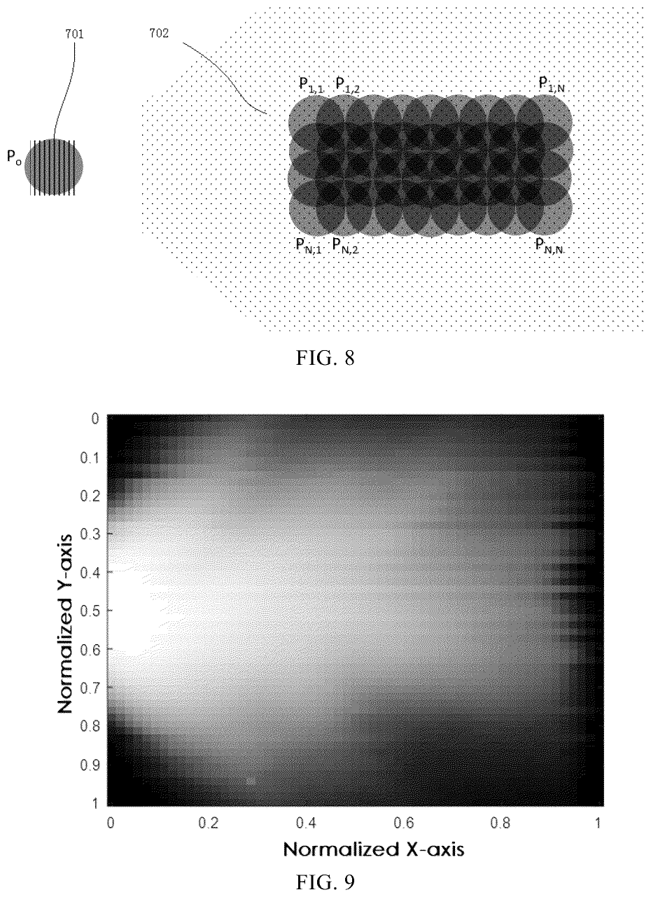

As shown in FIG. 1, the waveguide 700 includes an in-coupling grating 701 and an out-coupling grating 702. The in-coupling grating 701 and the out-coupling grating 702 are located at different positions on the waveguide 700. Light emerging from the light source is irradiated into the waveguide 700 by the in-coupling grating 701. The light source is, for example, a laser. Light from the laser is collimated before being irradiated onto the in-coupling grating 701. After modulation by the waveguide 700, the light emerges from the out-coupling grating 702. As shown in FIG. 8, the area of the out-coupling grating 702 is typically larger than that of the in-coupling grating 701. Uniformity and brightness of the light emerging from the out-coupling grating 702 have an important influence on display effect of the augmented reality device.

The lens 301 is capable of focusing light from a predetermined region of the out-coupling grating 702. The lens 301 may be, but not limited to, a convex lens 301, a Fresnel lens 301, and the like. The lens 301 may be a single lens or multiple lenses. The focused light facilitates conduction of light and measurement of brightness thereof.

In other examples, the lens 301 may also magnify the size of the light spot, or let it remain unchanged.

The fiber optic device is configured to conduct light received by the lens 301. Total reflection occurs to the light in the fiber optic device, thereby avoiding loss of light energy during transmission. The fiber optic device may be bent according to actual needs, so that the detection device can be positioned as appropriate.

Light emerging from the out-coupling grating 702 is irradiated onto the lens 301, and is refracted by the lens 301 before being incident onto the fiber optic device.

The detection device 100 is coupled to the receiver device 300 via the fiber optic device. The detection device 100 is configured to be able to calculate the brightness of the light coupled out of the predetermined region of the waveguide 700.

Furthermore, efficiency of the waveguide 700 can be calculated by measuring brightness of the light under different conditions.

The detection device 100 is typically of a relatively large volume and mass, and is not portable in use. Nevertheless, the fiber optic device can be bent at will, and the length and bending degree of the fiber optic device can be selected according to actual needs. The detection device 100 and the receiver device 300 are coupled together by the fiber optic device. The receiver device 300 is light and handy, and can be moved to a suitable position for measurement as appropriate. Accordingly, the receiver device 300 can be moved to any position for waveguide measurement. This enables the waveguide measurement device to be lighter, making the measurement of the waveguide 700 easier.

In addition, since the light is conducted within the fiber optic device with minor energy loss, measurement of the waveguide becomes more precise.

In one example, the fiber optic device includes a fiber body 200 and a fiber core 302. The fiber core 302 is connected to one end of the fiber body 200. The detection device 100 is coupled to the other end of the fiber body 200. The fiber core 302 is provided opposite to the lens 301. The fiber core 302 is configured to receive light received by the receiver device 300, e.g., a lens.

FIG. 1 illustrates the measurement principle of the waveguide measurement device according to an embodiment of the present disclosure.

For clarity of illustration, FIG. 1 only shows the case of an on-axis field measurement of the light emerging from the waveguide 700. The on-axis field refers to the light coupled out by the out-coupling grating 702 in a direction perpendicular to the emission surface 703 of the out-coupling grating 702. A collimated RGB beam, or an energy field, is incident on the in-coupling grating 701. The light propagates in the waveguide 700 with total internal reflection, and is finally transmitted out of the out-coupling grating 702. The transmitted light enters the receiver device 300. The light received by the receiver device 300 is focused by the lens 301 into the fiber optic device. The energy of the light is further measured by the detection device 100. For example, the detection device 100 may be a power meter or a detector.

In this example, under restriction of the diameter of the fiber core 302, the measurement device for the waveguide 700 can detect light coupled out of only a portion of the regions of the grating 702 at a time. Light from different sub-regions of the out-coupling grating 702 can be detected by moving the lens.

The brightness of the light in a predetermined region can be obtained using the radiative transfer equation, as shown in equation (1):

$$d {Φ}_{12} = \frac{{LdA}_{1} cos ( {θ}_{1} ) {dA}_{2} cos ( {θ}_{1} )}{{R}^{2}} \qquad ( 1 )$$

wherein dΦ₁₂ is an amount of power of a differential region dA₁ captured by the lens 301; A₂ is a clear aperture of the receiver device 300, R is a distance between the lens 301 and the waveguide 700, that is, the eye-relief distance, and the cosine term is to account for the projection area for the off-axis field measurement; L is the brightness or luminous flux of the light in equation (2). The off-axis field refers to the light coupled out by the out-coupling grating 702 whose direction forms an included angle with the normal direction of the emitting surface 703 of the out-coupling grating 702, wherein the included angle is greater than 0°, wherein, when the light is an on-axis field, θ₁=0°, cos(θ₁)=1, then the brightness or illuminance of the light can be calculated by equation (2).

$$L = \frac{{Φ}_{12} {R}^{2}}{{A}_{1} {A}_{2}} \qquad ( 2 )$$

wherein A₁ is the diameter of the light spot to be measured.

Since the fiber core 302 is of a small diameter, in order to measure the intensity of the off-axis field coupled out of the out-coupling grating 702, the position of the receiver device 300 needs to be changed so that the receiving surface 303 of the lens 301 is parallel to the direction of the waveguide.

Since the waveguide 700 generates both on-axis and off-axis fields simultaneously, the receiver should also be able to detect off-axis fields. As is shown in FIG. 2, the process includes generating an on-axis field and an off-axis field. Then, the receiver device is used for receiving the on-axis field and/or the off-axis field. The receiver device can scan the field laterally (e.g., +x distance and −x distance) and beyond the viewing angle range of the waveguide FOV. Owing to the coupling via the fiber optic device, the receiver device can be easily mounted on a motorized translation and rotation platform to detect on-axis and/or off-axis fields by scanning.

In one example, the waveguide measurement device further includes a movement device. The receiver device 300 is provided on the movement device. The movement device is configured to be able to move the receiver device 300 in a predetermined direction and/or reorient the lens 301.

The movement device can be a linear displacement device, such as a linear motor, a screw module, etc.; it can also be a device that realizes rotary motion, swing motion, etc., such as a servo motor, a pendulum cylinder, a piezoelectric ceramic rotation device, and the like.

In this way, the waveguide measurement device is able to measure both off-axis and on-axis fields of the waveguide 700.

In addition to changing the position of the receiver device 300 and/or the direction of the lens 301, the position of the light spot on the out-coupling grating 702 to be acquired by the waveguide measurement device can also be changed by the movement device, so as to realize detection of intensity of different regions of the out-coupling grating 702.

In an example, the movement device includes a first linear displacement device 501 and a first rotation device 502, the first rotation device 502 and the first linear displacement device 501 being connected and secured to each other, the receiver device 300 being provided on the first rotation device 502 or the first linear displacement device 501.

The first linear displacement device 501 is a linear motor or a screw module. The first rotation device 502 is a servo motor, a pendulum cylinder, a piezoelectric ceramic rotation device, or the like. The first linear displacement device 501 can realize linear movement of the receiver device 300. The first rotation device 502 can realize direction adjustment of the lens 301. By means of the movement device, the waveguide measurement device measures the on-axis field and/or the off-axis field, and performs detection on different sub-regions of the out-coupling grating of the waveguide.

In one example, the waveguide measurement device further includes an off-axis field generating device. The off-axis field generating device is configured to be able to assist the waveguide 700 in coupling out an off-axis field. For example, by rotating the waveguide 700 and/or changing the angle at which the collimated light is incident on the in-coupling grating 701, the out-coupling grating 702 can radiate the off-axis field. The off-axis field generating device can effectively assist the waveguide 700 to generate an off-axis field, thereby improving the efficiency of waveguide measurement.

In one example, the off-axis field generating device includes a second rotation device 601. The second rotation device 601 is configured to rotate the waveguide 700 about the center of the in-coupling grating 701 of the waveguide 700.

For example, the second rotation device 601 is a servo motor, a pendulum cylinder, a piezoelectric ceramic rotation device, or the like.

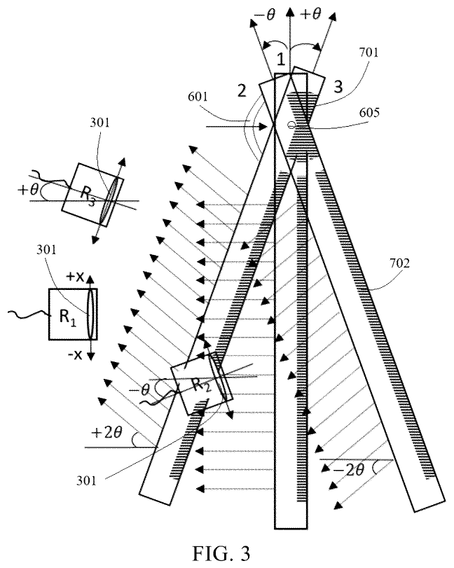

As shown in FIG. 3, upon rotation, the waveguide 700 rotates about the rotation center of the coupled grating 701, e.g., clockwise or counterclockwise. In the case that the position of the light source remains unchanged, the in-coupling grating 701 is rotated relative to the X axis by an angle θ, for example, rotated by an angle θ clockwise or counterclockwise. Correspondingly, the light radiated from the out-coupling grating 702 is rotated relative to the Z-axis by an angle of 2θ, i.e., +2θ or −2θ. Brightness of the off-axis field in different regions of the waveguide 700 can be measured by adjusting the observation direction of the receiver device 300 by the movement device and scanning the waveguide 700 along a surface parallel to it.

Specifically, in a first state, the waveguide 700 is rotated clockwise by an angle of θ to reach the position R3. The angle between the light emerging from the out-coupling grating 702 and the Z axis is +20. At this moment, the receiving apparatus 300 is located at the position R3. The included angle between the optical axis of the lens 301 and the Z axis is set to an angle of +θ. When measuring an off-axis field, the receiving surface 303 is parallel to the transmitting surface 703. The lens 301 performs scanning in a direction parallel to the waveguide 700.

In a second state, the waveguide 700 is rotated counterclockwise by an angle θ to reach the position R2. The angle between the light emerging from the out-coupling grating 702 and the Z axis is −2θ. At this moment, the receiving apparatus 300 is located at the position R2. The included angle between the optical axis of the lens 301 and the Z axis is set to an angle of −θ. When measuring an off-axis field, the receiving surface 303 is parallel to the transmitting surface 703. The lens 301 performs scanning in a direction parallel to the waveguide 700.

When the waveguide 700 is at the position R1, the direction of the waveguide 700 is parallel to the X axis. The receiver device 300 is located at the position R1. The lens 301 is parallel to the waveguide 700. In this state, the waveguide measurement device can measure an on-axis field.

For example, a rotation shaft 605 may be provided at the rotation center of the coupled grating 701, and the waveguide 700 may be driven by a rotation device to rotate about the rotation shaft 605.

Alternatively, the second rotation device 601 includes a driver and a rotation bearing. The waveguide 700 is secured on the rotation bearing. The center of the in-coupling grating 701 coincides with the center of the rotary bearing. The driver drives the rotation bearing to rotate, and in turn causes the waveguide 700 to rotate.

In one example, the off-axis field generating device includes a reflection device 602. The reflection device 602 is configured to reflect the collimated light so that the collimated light is obliquely incident onto the in-coupling grating 701 of the waveguide 700.

For example, the reflection device 602 is an emitting mirror, a prism, or the like. The optical path of the collimated light is changed by the reflection device 602, so that the collimated light is obliquely incident on the in-coupling grating 701. For example, the included angle between the X-axis direction of the incident light is an angle θ, for example, an angle of +θ and an angle of −θ.

In this example, the provision of reflection device 602 assists in generating off-axis fields without requiring movement of waveguide 700. This makes generation of off-axis fields easier and simplifies the measurement process.

Since the in-coupling grating 701 is of a small area, light reflected by the reflection device may not be incident onto the in-coupling grating 701. If so, the waveguide measurement device will not be able to measure the off-axis field.

In one example, the off-axis field generating device further includes a second linear displacement device 603 and a third rotation device 604. The third rotation device 604 and the second linear displacement device 603 are connected and secured to each other. The reflection device 602 is provided on the third rotation device 604 or the second linear displacement device 603. The reflection device 602 can be rotated and moved parallel to the waveguide 700.

The second linear displacement device 603 may be, but not limited to, a linear motor, a lead screw device, and the like. The third rotation device 604 is a device capable of swinging and/or rotating. The third rotation device 604 is a servo motor, a pendulum cylinder, a piezoelectric ceramic rotation device, or the like.

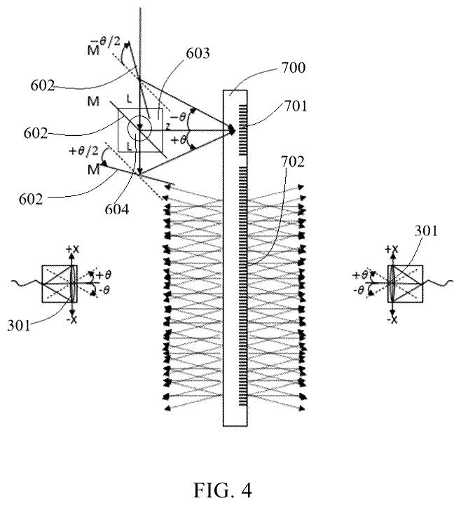

For example, as shown in FIG. 4, the third rotation device 604 is secured on the second linear displacement device 603. The reflection device 602 is secured on the third rotation device 604.

Collimated light is incident along the Z-axis direction. In the initial position, the waveguide 700 is parallel to the X-axis direction. The reflection device 602 is at a 45° angle to the X-axis so that the collimated light is incident on the in-coupling grating 701 along the Z-axis.

In the first state, the reflection device 602 is rotated clockwise by an angle of θ/2, i.e., −θ/2. In order to let the reflected light be incident on the in-coupling grating 701, the second linear displacement device 603 moves upward along the X-axis by a distance L. The angle between the light incident on the in-coupling grating 701 and the Z axis is θ°, i.e., −θ. At this moment, the off-axis field emerging from the out-coupling grating 702 is at an angle of +θ with respect to the Z-axis. The receiver device 300 scans parallel to the waveguide 700, so that the intensity of light in different regions can be measured.

In the second state, the reflection device 602 is rotated counterclockwise by an angle of θ/2, i.e., +θ/2. In order to let the reflected light be incident on the in-coupling grating 701, the second linear displacement device 603 moves downward along the X-axis by a distance L. The angle between the light incident on the in-coupling grating 701 and the Z axis is θ°, that is, +θ. At this moment, the off-axis field emerging from the out-coupling grating 702 is at an angle of −θ with respect to the Z-axis. The receiver device 300 scans parallel to the waveguide 700, so that the intensity of light in different regions can be measured.

In addition, light can emerge from the out-coupling grating 702 in different directions. For example, as shown in FIG. 4, both on-axis and off-axis fields can be coupled out on each of the two opposite sides of the waveguide. By providing the receiver device 300 on different sides of the out-coupling grating 702, the brightness of the light emerging from the out-coupling grating 702 in different directions can be measured.

In other examples, the second linear displacement device 603 is secured on the third rotation device 604. The reflection device 602 is secured on the second linear displacement device 603. In this way, it is also possible to generate off-axis fields via the waveguide.

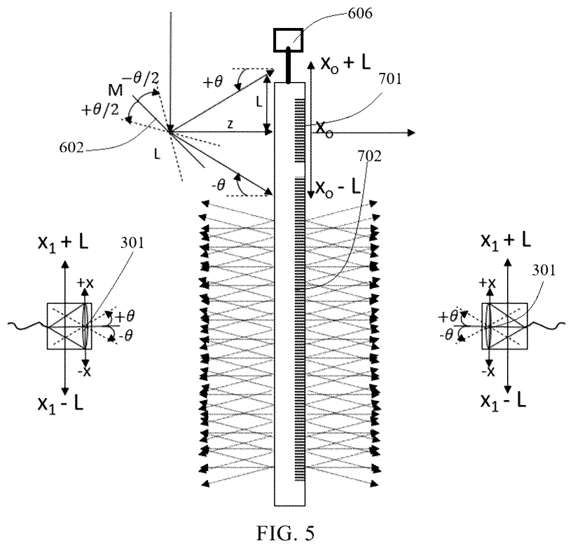

In one example, as shown in FIG. 5, the off-axis field generating device includes a reflection device 602 and a third linear displacement means 606. The third linear displacement device 606 is configured to move the waveguide 700 to enable light reflected by the reflection device 602 to be obliquely incident on the in-coupling grating 701 of the waveguide 700.

In this example, the third linear displacement device 606 may be, but is not limited to, a linear motor, a lead screw device, and the like. For example, in the initial position, the angle between the reflection device and the Z axis is 45°.

In the first state, the reflection device 602 is rotated clockwise by an angle of θ/2, i.e., −θ/2. In order to let the reflected light be incident on the in-coupling grating 701, the third linear displacement device 606 moves downward along the X-axis by a distance L, i.e., −L. The angle between the light incident on the in-coupling grating 701 and the Z axis is θ°, i.e., −θ. At this moment, the off-axis field emerging from the out-coupling grating 702 is +θ with respect to the Z-axis. The receiver device 300 scans parallel to the waveguide 700, so that intensity of light in different regions can be measured.

In the second state, the reflection device 602 is rotated counterclockwise by an angle of θ/2, i.e., +θ/2. In order to let the reflected light be incident on the in-coupling grating 701, the third linear displacement device 606 moves upward along the X-axis by a distance L, i.e., +L. The angle between the light incident on the in-coupling grating 701 and the Z axis is θ°, i.e., +θ. At this moment, the off-axis field emerging from the out-coupling grating 702 is −θ with respect to the Z-axis. The receiver device 300 scans parallel to the waveguide 700, so that intensity of light in different regions can be measured.

In addition, the out-coupling grating 702 can emit light in different directions. By providing the receiver device 300 at different positions on the out-coupling grating 702, the brightness of light emerging from the out-coupling grating 702 in different directions can be measured.

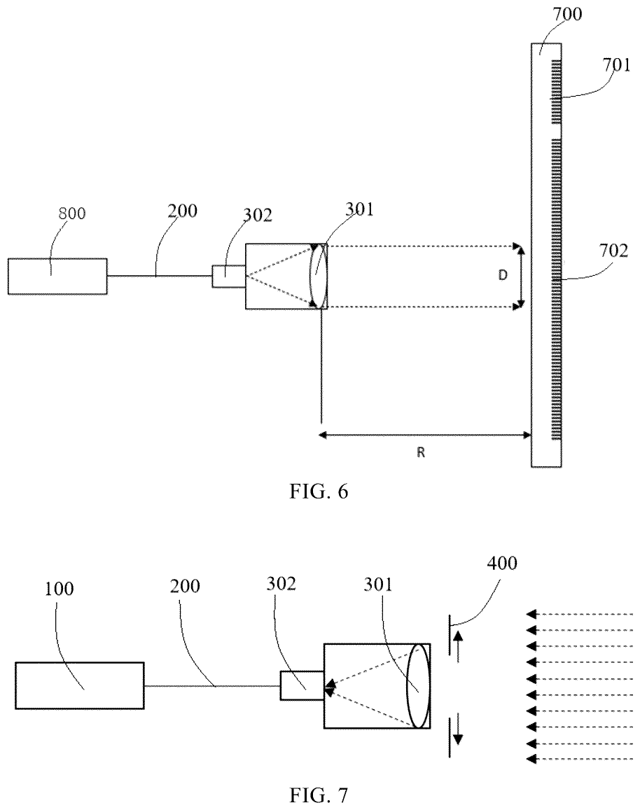

According to another embodiment of the present disclosure, a method of measuring the power of a waveguide 700 by a waveguide measurement device is provided. The method includes:
S1. Calibration. Referring to FIG. 6 and FIG. 7:
a. Measuring the optical loss of the receiver device 300;
b. Measuring the spot size on the target plane (e.g., waveguide 700);
c. Measuring the clear aperture of the receiver device 300.
S2. Optical alignment of the receiver device 300 and the waveguide 700.
S3. Measuring the coupled power of the in-coupling grating 701, including:
A. Measuring the incident power of the in-coupling grating 701 (e.g., P₀₀);
B. Measuring the transmission power of the in-coupling grating 701 (e.g., P₀₁);
C. Deducing the power of the light coupled to the waveguide 700 according to steps A and B, i.e., P₀₀−P₀₁.
S4. S3 can be performed with and without the linear polarizer.
S5. The receiver device 300 scanning, at eye-relief distance, the out-coupling grating 702 or predetermined sub-regions of the out-coupling grating 702 to measure power of each color light of red, green, and blue; for example, performing multiple point sampling (i.e., P_{1, 1}, . . . . P_{N,N}).
S6. Computing the integrated power of the light reaching the observer, taking the resolution of the scanning configuration into account.
S7. Computing the efficiency at each sub-region by dividing the powers of the sub-regions of the out-coupling grating 702 with the coupled powers, e.g., P(i,j)/(P₀₀−P₀₁)*100.
S8. For luminance measurement, estimating the luminous flux according to the power spectrum and photopic response curve of each color light.
S9. Determining luminous flux, i.e., brightness, of each measurement point in equation (2).

In one example, the waveguide measurement device further includes a receiver device 400. The receiver device 400 is located on the light incident side of the lens 301. The receiver device 400 is opposite to the lens 301.

The receiver device 400 is configured to vary the cross-sectional size of the light incident on the lens 301 so as to determine the clear aperture of the receiver device 300. As shown in FIG. 7, the method for determining the clear aperture is as follows:

First, the collimated light is aligned with the receiver device 400, with the help of a power meter reading the brightness of the light incident on the lens 301.

Then, the receiver device 400 is placed on the light incident side of the lens 301. For example, the receiver device 400 is arranged coaxially with the lens 301.

Finally, the aperture of the receiver device 400 is gradually increased until no power change position is observed on the power meter.

The diameter of the aperture is equal to the clear aperture of the receiver device 300 under the condition of the maximum power and no power change. The clear aperture is A₂.

Furthermore, the optical losses of the receiver device 300 can also be characterized in the same set-up. For example, optical loss can be determined by a simple comparison of power meter readings with and without receiver 300 in the optical path. FIG. 6 shows a method of determining the spot size of light of each color of RGB on the waveguide 700. Details are as follows:

The detection device 100 at one end of the fiber body is replaced with a light-emitting device 800. For example, the light emitting device 800 can emit light of three colors, i.e., red, green and blue. The light goes through the fiber body 200, exits via the fiber core 302 and reaches the lens 301. The light refracted by the lens 301 radiates on the out-coupling grating 702 and forms a light spot. The size of the spot of the set color light can be acquired by measuring. The size of the spot is A₁.

The brightness L of the out-coupling grating 702 can be calculated by measuring the power Φ₁₂ in the regions A₁ and A₂ and measuring the distance R between the emerging surface and the incident surface, that is, eye-relief distance.

Since the out-coupling grating 702 is of a relatively large area and the fiber core 302 is of a relatively small diameter, it is necessary to use a waveguide measurement device to perform multiple samplings on the out-coupling grating 702 at different positions, in order to precisely measure the brightness of the light emerging from the waveguide 700 and light efficiency thereof. For example, as shown in FIG. 8, P₀ on the left side of FIG. 8 is the in-coupling grating 701, while the right side is the out-coupling grating 702. The sampling sub-regions for power measurement is (P_{1,1}, . . . . P_{N,N}). FIG. 8 is a combined graph of the intensities of light of multiple sampled sub-regions.

FIG. 9 shows a combined luminance graph generated by scanning an out-coupling grating at eye-relief distance from the waveguide to the waveguide measurement device according to an embodiment of the present disclosure. Each pixel in FIG. 9 represents a sampling sub-region P_{i,j} in FIG. 8. The receiver device 300 scans the waveguide 700 in the X-axis direction and the Y-axis direction with sub-millimeter resolution. In this Figure, uniformity and brightness of the light reaching the user can be calculated by summing the power of each pixel and taking into account the compensation of the scanning.

The abscissa of FIG. 9 is the normalized X coordinate axis, and the ordinate thereof is the luminance signal of the light of the predetermined color in the normalized X-axis direction. It can be seen from FIG. 8 and FIG. 9 that since the in-coupling grating is located to the left of the out-coupling grating, as shown in FIG. 9, the region with the highest light intensity is in the middle of the left side of FIG. 9, while the brightness gradually decreases from left to right along the X-axis direction and gradually decreases from the middle to two sides along the Y-axis direction.

The luminous flux of a certain sub-region of the out-coupling grating can be estimated according to the power spectrum and photopic response curve of each color light.

The various embodiments mentioned above focus on differences therebetween. The advantageous features that are different between the various embodiments can be combined to form a more preferred embodiment as long as they are not contradictory to each other, and unnecessary details thereof is omitted here for the sake of brevity.

While some specific embodiments of the present invention have been described in detail by way of examples, it should be understood by those skilled in the art that the above examples are for illustration only and are not intended to limit the scope of the present invention. It will be apparent to those skilled in the art that modifications to the above embodiment can be made without departing from the scope or spirit of the present invention. The scope of the present invention is limited by the appended claims.

1. A waveguide measurement device, comprising:
a receiver device comprising a lens, the lens being configured to receive light coupled out of a predetermined region of a waveguide;
a fiber optic device configured to conduct the light received by the lens; and
a detection device coupled to the receiver device via the fiber optic device, the detection device being configured to calculate an intensity of the light coupled out of the predetermined region of the waveguide.

2. The waveguide measurement device of claim 1, further comprising a movement device on which the receiver device is provided, the movement device being configured to move the receiver device in a predetermined direction and/or to reorient the lens.

3. The waveguide measurement device of claim 2, wherein the movement device comprises a first linear displacement device and a first rotation device, the first rotation device and the first linear displacement device being connected and secured to each other, the receiver device being provided on the first rotation device or the first linear displacement device.

4. The waveguide measurement device of claim 1, further comprising an off-axis field generating device configured to assist the waveguide in coupling out an off-axis field.

5. The waveguide measurement device of claim 4, wherein the off-axis field generating device comprises a second rotation device configured to rotate the waveguide about a center of an in-coupling grating of the waveguide.

6. The waveguide measurement device of claim 4, wherein the off-axis field generating device comprises a reflection device configured to reflect collimated light so that the collimated light is incident obliquely onto an in-coupling grating of the waveguide.

7. The waveguide measurement device of claim 6, further comprising a second linear displacement device and a third rotation device, the third rotation device and the second linear displacement device being connected and secured to each other, the reflection device being provided on the third rotation device or the second linear displacement device and configured to be moved parallel to the waveguide and to be rotated.

8. The waveguide measurement device of claim 6, further comprising a third linear displacement device configured to move the waveguide so that the light reflected by the reflection device is incident obliquely onto the in-coupling grating of the waveguide.

9. The waveguide measurement device of claim 1, further comprising an aperture device, the aperture device being located on a light incident side of the lens, and the aperture device being opposite to the lens.

10. The waveguide measurement device of claim 1, wherein the fiber optic device comprises a fiber body and a fiber core, the fiber core being connected to one end of the fiber body, and the detection device being coupled to the other end of the fiber body, the fiber core being provided opposite to the lens.
